(19) United States
(12) Patent Application Publication
(10) Pub. No.: US 2017/0262894 A1
(43) Pub. Date: Sep. 14, 2017

(54) EXPANDING TARGETING CRITERIA FOR CONTENT ITEMS BASED ON USER CHARACTERISTICS AND WEIGHTS ASSOCIATED WITH USERS SATISFYING THE TARGETING CRITERIA

(71) Applicant: Facebook, Inc., Menlo Park, CA (US)

(72) Inventors: Rituraj Kirti, Los Altos, CA (US); Ryan Patrick Batterman, Salinas, CA (US)

(21) Appl. No.: 15/068,526

(22) Filed: Mar. 11, 2016

(51) Int. Cl. G06Q 30/02; G06F 17/30

(52) U.S. Cl. CPC G06Q 30/0269; G06F 17/30598

(57) ABSTRACT

An online system receives an advertisement request (“ad request”) including an advertisement, targeting criteria identifying characteristics of users eligible to be presented with the advertisement, and one more rules associating weights with characteristics of users. Based on the rules included in the ad request, the online system generates a cluster model that is applied to characteristics of users who do not have characteristics satisfying the targeting criteria in the ad request to generate cluster scores. Users with cluster scores equaling or exceeding a cluster group cutoff score are identified as eligible to be presented with the advertisement in the ad request despite not having characteristics satisfying the targeting criteria in the ad request. Hence, the ad request is eligible for presentation to users having characteristics satisfying the ad request's targeting criteria or having cluster scores equaling or exceeding the cluster group cutoff score.

### BACKGROUND

This disclosure relates generally to presenting content via an online system and more particularly to targeting content items for presentation to users via the online system.

Traditionally, content providers have attempted to tailor content presented to different users based on expected demographics of users. Even before the advent of broadcast media, an entity (e.g., a business) promoting a product or a service sought to present content about the product or service in publications or other outlets viewed by typical consumers of the product. As publishing and broadcasting costs fell, more media catered to niche audiences, allowing entities to more finely tune presentation of content to narrower groups of media consumers. Nonetheless, many content items mainly cater to the typical consumer of media in which the content items are presented, causing atypical consumers of media to encounter irrelevant content items. With the advent of personalized digital media, content items may be matched to an individual user according to known traits of the user. However, producers of personalized digital media often have limited information about a user, so a producer may miss an opportunity for presenting a user with content relevant to the user because the producer lacks explicit user information indicating that the user is in a target audience for the content.

### SUMMARY

An online system receives an advertisement request (“ad request”) from a user that includes advertisement content for presentation to users (also referred to as an “advertisement”) and a bid amount specifying an amount of compensation an advertiser associated with the ad request provides the online system for presenting the advertisement in the ad request, for a user interacting with the advertisement in the ad request, or for another suitable interaction with the advertisement in the ad request. The ad request also includes targeting criteria specifying specify one or more characteristics of users eligible to be presented with the advertisement in the ad request. Hence, the online system includes the ad request in one or more selection processes selecting advertisements for presentation to users having characteristics satisfying at least a threshold number of the targeting criteria included in the ad request. Hence, online system users having characteristics satisfying at least the threshold number of the targeting criteria included in the ad request comprise a target audience for the ad request. The user providing the ad request to the online system also associates weights with different users in the target audience. For example, a weight associated with a user in the target audience is based on one or more characteristics of the user and one or more rules specified by the user providing the ad request to the online system associating weights with different characteristics.

To expand the possible audience for an advertisement, the online system determines a cluster group of users having characteristics similar to characteristics of users in the target audience of the ad request. Characteristics associated with the cluster group may be associated with the ad request and used to identify additional users having characteristics associated with the cluster group but who do not have at least the threshold number of characteristics matching targeting criteria associated with the ad request. To determine whether users are included in a cluster group associated with the targeting criteria of the ad request, the online system trains a cluster model to determine a measure of similarity between characteristics of a user and targeting criteria using characteristics of users in the target audience of the ad request and weights associated with users in the target audience by the user who provided the ad request to the online system. Training the cluster model using the weights associated with users in the target audience by the user who provided the ad request to the online system allows the cluster model to account for relative importance of various characteristics to the user who provided the ad request to the online system.

The online system applies the trained cluster model to characteristics of a user to generate a cluster score for the user and determines whether to include the user in the cluster group based on the user's cluster score. In one embodiment, cluster model parameters are weights applied to various characteristics of a user, which are determined from weights associated with users in the target audience by the user who provided the ad request to the online system as well as characteristics of users in the target audience. Accounting for weights associated with users in the target audience allows the user who provided the ad request to the online system to bias cluster scores generated for different users to tailor the cluster group for preferences or goals of the user who provided the ad request to the online system. The online system generates the cluster score for a user based on cluster model parameters and characteristics of the user. In one embodiment, a cluster score associated with a user is compared to a cluster cutoff score. If the cluster score associated with the user equals or exceeds the cluster cutoff score, the user is included in the cluster group. This allows the online system to identify the user as eligible to be presented with the ad request if the user does not have characteristics satisfying at least a threshold number of targeting criteria included in the ad request.

### BRIEF DESCRIPTION OF THE DRAWINGS

FIG. 1 is a block diagram of a system environment in which an online system operates, in accordance with an embodiment.

FIG. 2 is a block diagram of an online system, in accordance with an embodiment.

FIG. 3 is an example of a target audience and a cluster group for an advertisement request received by the online system, in accordance with an embodiment.

FIG. 4 is a flowchart of a method for creating a cluster group for an advertisement request for identifying users eligible to be presented with an advertisement from the advertisement request, in accordance with an embodiment.

The figures depict various embodiments for purposes of illustration only. One skilled in the art will readily recognize from the following discussion that alternative embodiments of the structures and methods illustrated herein may be employed without departing from the principles described herein.

### DETAILED DESCRIPTION

### System Architecture

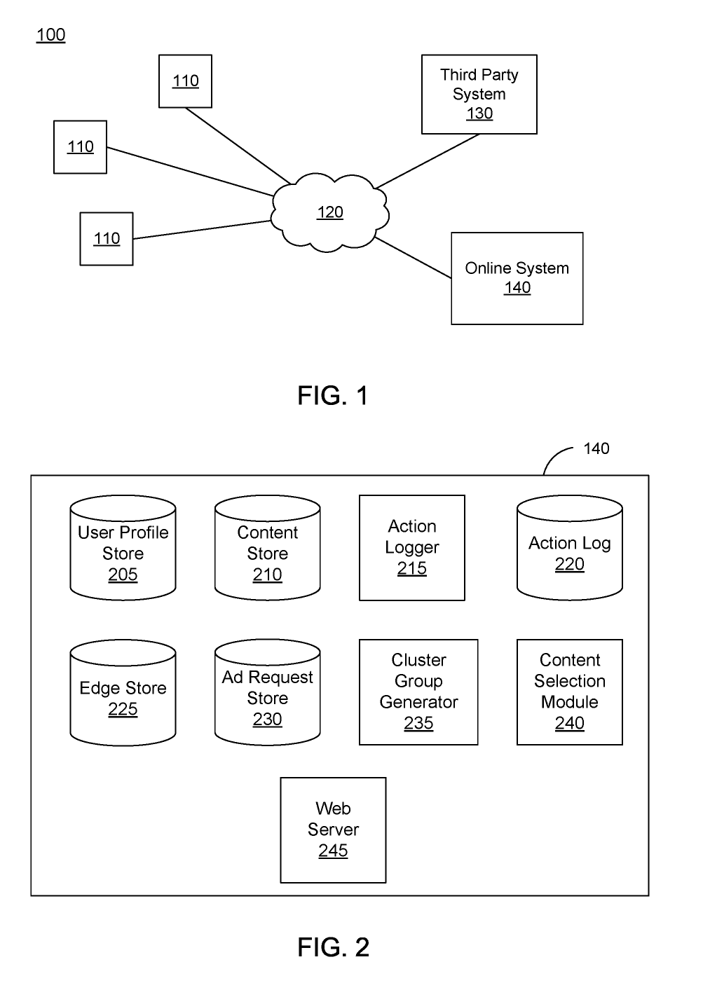

FIG. 1 is a block diagram of a system environment 100 for an online system 140. The system environment 100 shown by FIG. 1 comprises one or more client devices 110, a network 120, one or more third-party systems 130, and the online system 140. In alternative configurations, different and/or additional components may be included in the system environment 100. The embodiments described herein may be adapted to online systems that are social networking systems, content sharing networks, or other systems providing content to users.

The client devices 110 are one or more computing devices capable of receiving user input as well as transmitting and/or receiving data via the network 120. In one embodiment, a client device 110 is a conventional computer system, such as a desktop or a laptop computer. Alternatively, a client device 110 may be a device having computer functionality, such as a personal digital assistant (PDA), a mobile telephone, a smartphone, a smartwatch or another suitable device. A client device 110 is configured to communicate via the network 120. In one embodiment, a client device 110 executes an application allowing a user of the client device 110 to interact with the online system 140. For example, a client device 110 executes a browser application to enable interaction between the client device 110 and the online system 140 via the network 120. In another embodiment, a client device 110 interacts with the online system 140 through an application programming interface (API) running on a native operating system of the client device 110, such as IOS® or ANDROID™.

The client devices 110 are configured to communicate via the network 120, which may comprise any combination of local area and/or wide area networks, using both wired and/or wireless communication systems. In one embodiment, the network 120 uses standard communications technologies and/or protocols. For example, the network 120 includes communication links using technologies such as Ethernet, 802.11, worldwide interoperability for microwave access (WiMAX), 3G, 4G, code division multiple access (CDMA), digital subscriber line (DSL), etc. Examples of networking protocols used for communicating via the network 120 include multiprotocol label switching (MPLS), transmission control protocol/Internet protocol (TCP/IP), hypertext transport protocol (HTTP), simple mail transfer protocol (SMTP), and file transfer protocol (FTP). Data exchanged over the network 120 may be represented using any suitable format, such as hypertext markup language (HTML) or extensible markup language (XML). In some embodiments, all or some of the communication links of the network 120 may be encrypted using any suitable technique or techniques.

One or more third party systems 130 may be coupled to the network 120 for communicating with the online system 140, which is further described below in conjunction with FIG. 2. In one embodiment, a third party system 130 is an application provider communicating information describing applications for execution by a client device 110 or communicating data to client devices 110 for use by an application executing on the client device 110. In other embodiments, a third party system 130 provides content or other information for presentation via a client device 110. A third party system 130 may also communicate information to the online system 140, such as advertisements, content, or information about an application provided by the third party system 130.

In some embodiments, one or more of the third party systems 130 provide content to the online system 140 for presentation to users of the online system 140 and provide compensation to the online system 140 in exchange for presenting the content. For example, a third party system 130 provides advertisement requests, which are further described below in conjunction with FIG. 2, including advertisements for presentation and amounts of compensation provided by the third party system 130 to the online system 140 in exchange presenting the advertisements to the online system 140. Content presented by the online system 140 for which the online system 140 receives compensation in exchange for presenting is also referred to herein as “sponsored content.” Sponsored content from a third party system 130 may be associated with the third party system 130 or with another entity on whose behalf the third party system 130 operates.

FIG. 2 is a block diagram of an architecture of the online system 140. The online system 140 shown in FIG. 2 includes a user profile store 205, a content store 210, an action logger 215, an action log 220, an edge store 225, an advertisement (“ad”) request store 230, a cluster group generator 235, a content selection module 240, and a web server 245. In other embodiments, the online system 140 may include additional, fewer, or different components for various applications. Conventional components such as network interfaces, security functions, load balancers, failover servers, management and network operations consoles, and the like are not shown so as to not obscure the details of the system architecture.

Each user of the online system 140 is associated with a user profile, which is stored in the user profile store 205. A user profile includes declarative information about the user that was explicitly shared by the user and may also include profile information inferred by the online system 140. In one embodiment, a user profile includes multiple data fields, each describing one or more attributes of the corresponding online system user. Examples of information stored in a user profile include biographic, demographic, and other types of descriptive information, such as work experience, educational history, gender, hobbies or preferences, location and the like. A user profile may also store other information provided by the user, for example, images or videos. In certain embodiments, images of users may be tagged with information identifying the online system users displayed in an image, with information identifying the images in which a user is tagged stored in the user profile of the user. A user profile in the user profile store 205 may also maintain references to actions by the corresponding user performed on content items in the content store 210 and stored in the action log 220.

While user profiles in the user profile store 205 are frequently associated with individuals, allowing individuals to interact with each other via the online system 140, user profiles may also be stored for entities such as businesses or organizations. This allows an entity to establish a presence on the online system 140 for connecting and exchanging content with other online system users. The entity may post information about itself, about its products or provide other information to users of the online system 140 using a brand page associated with the entity's user profile. Other users of the online system 140 may connect to the brand page to receive information posted to the brand page or to receive information from the brand page. A user profile associated with the brand page may include information about the entity itself, providing users with background or informational data about the entity. In some embodiments, the brand page associated with the entity's user profile may retrieve information from one or more user profiles associated with users who have interacted with the brand page or with other content associated with the entity, allowing the brand page to include information personalized to a user when presented to the user.

The content store 210 stores objects that each represents various types of content. Examples of content represented by an object include a page post, a status update, a photograph, a video, a link, a shared content item, a gaming application achievement, a check-in event at a local business, a brand page, or any other type of content. Online system users may create objects stored by the content store 210, such as status updates, photos tagged by users to be associated with other objects in the online system 140, events, groups or applications. In some embodiments, objects are received from third-party applications or third-party applications separate from the online system 140. In one embodiment, objects in the content store 210 represent single pieces of content, or content “items.” Hence, online system users are encouraged to communicate with each other by posting text and content items of various types of media to the online system 140 through various communication channels. This increases the amount of interaction of users with each other and increases the frequency with which users interact within the online system 140.

The action logger 215 receives communications about user actions internal to and/or external to the online system 140, populating the action log 220 with information about user actions. Examples of actions include adding a connection to another user, sending a message to another user, uploading an image, reading a message from another user, viewing content associated with another user, and attending an event posted by another user. In addition, a number of actions may involve an object and one or more particular users, so these actions are associated with the particular users as well and stored in the action log 220.

The action log 220 may be used by the online system 140 to track user actions on the online system 140, as well as actions on third party systems 130 that communicate information to the online system 140. Users may interact with various objects on the online system 140, and information describing these interactions is stored in the action log 220. Examples of interactions with objects include: commenting on posts, sharing links, checking-in to physical locations via a client device 110, accessing content items, and any other suitable interactions. Additional examples of interactions with objects on the online system 140 that are included in the action log 220 include: commenting on a photo album, communicating with a user, establishing a connection with an object, joining an event, joining a group, creating an event, authorizing an application, using an application, expressing a preference for an object (“liking” the object), engaging in a transaction, viewing an object (e.g., a content item), and sharing an object (e.g., a content item) with another user. Additionally, the action log 220 may record a user's interactions with advertisements on the online system 140 as well as with other applications operating on the online system 140. In some embodiments, data from the action log 220 is used to infer interests or preferences of a user, augmenting the interests included in the user's user profile and allowing a more complete understanding of user preferences.

The action log 220 may also store user actions taken on a third party system 130, such as an external website, and communicated to the online system 140. For example, an e-commerce website may recognize a user of an online system 140 through a social plug-in enabling the e-commerce website to identify the user of the online system 140. Because users of the online system 140 are uniquely identifiable, e-commerce web sites, such as in the preceding example, may communicate information about a user's actions outside of the online system 140 to the online system 140 for association with the user. Hence, the action log 220 may record information about actions users perform on a third party system 130, including webpage viewing histories, advertisements that were engaged, purchases made, and other patterns from shopping and buying. Additionally, actions a user performs via an application associated with a third party system 130 and executing on a client device 110 may be communicated to the action logger 215 by the application for recordation and association with the user in the action log 220.

In one embodiment, the edge store 225 stores information describing connections between users and other objects on the online system 140 as edges. Some edges may be defined by users, allowing users to specify their relationships with other users. For example, users may generate edges with other users that parallel the users' real-life relationships, such as friends, co-workers, partners, and so forth. Other edges are generated when users interact with objects in the online system 140, such as expressing interest in a page on the online system 140, sharing a link with other users of the online system 140, and commenting on posts made by other users of the online system 140.

In one embodiment, an edge may include various features each representing characteristics of interactions between users, interactions between users and objects, or interactions between objects. For example, features included in an edge describe a rate of interaction between two users, how recently two users have interacted with each other, a rate or an amount of information retrieved by one user about an object, or numbers and types of comments posted by a user about an object. The features may also represent information describing a particular object or a particular user. For example, a feature may represent the level of interest that a user has in a particular topic, the rate at which the user logs into the online system 140, or information describing demographic information about the user. Each feature may be associated with a source object or user, a target object or user, and a feature value. A feature may be specified as an expression based on values describing the source object or user, the target object or user, or interactions between the source object or user and target object or user; hence, an edge may be represented as one or more feature expressions.

The edge store 225 also stores information about edges, such as affinity scores for objects, interests, and other users. Affinity scores, or “affinities,” may be computed by the online system 140 over time to approximate a user's interest in an object or in another user in the online system 140 based on the actions performed by the user. A user's affinity may be computed by the online system 140 over time to approximate the user's interest in an object, in a topic, or in another user in the online system 140 based on actions performed by the user. Computation of affinity is further described in U.S. patent application Ser. No. 12/978,265, filed on Dec. 23, 2010, U.S. patent application Ser. No. 13/690,254, filed on Nov. 30, 2012, U.S. patent application Ser. No. 13/689,969, filed on Nov. 30, 2012, and U.S. patent application Ser. No. 13/690,088, filed on Nov. 30, 2012, each of which is hereby incorporated by reference in its entirety. Multiple interactions between a user and a specific object may be stored as a single edge in the edge store 225, in one embodiment. Alternatively, each interaction between a user and a specific object is stored as a separate edge. In some embodiments, connections between users may be stored in the user profile store 205, or the user profile store 205 may access the edge store 225 to determine connections between users.

One or more advertisement requests (“ad requests”) are included in the ad request store 230. An ad request includes advertisement content, also referred to as an “advertisement,” and a bid amount. The advertisement is text, image, audio, video, or any other suitable data presented to a user. In various embodiments, the advertisement also includes a landing page specifying a network address to which a user is directed when the advertisement content is accessed. The bid amount is associated with an ad request by an advertiser and is used to determine an expected value, such as monetary compensation, provided by the advertiser to the online system 140 if an advertisement in the ad request is presented to a user, if the advertisement in the ad request receives a user interaction when presented, or if any suitable condition is satisfied when the advertisement in the ad request is presented to a user. For example, the bid amount specifies a monetary amount that the online system 140 receives from the advertiser if an advertisement in an ad request is displayed. In some embodiments, the expected value to the online system 140 of presenting the advertisement may be determined by multiplying the bid amount by a probability of the advertisement being accessed by a user.

Additionally, an ad request may include one or more targeting criteria specified by the advertiser. Targeting criteria included in an ad request specify one or more characteristics of users eligible to be presented with advertisement content in the ad request. For example, targeting criteria are used to identify users having user profile information, edges, or actions satisfying at least one of the targeting criteria. Hence, targeting criteria allow an advertiser to identify users having specific characteristics, simplifying subsequent distribution of content to different users.

In one embodiment, targeting criteria may specify actions or types of connections between a user and another user or object of the online system 140. Targeting criteria may also specify interactions between a user and objects performed external to the online system 140, such as on a third party system 130. For example, targeting criteria identifies users who have taken a particular action, such as sent a message to another user, used an application, joined a group, left a group, joined an event, generated an event description, purchased or reviewed a product or service using an online marketplace, requested information from a third party system 130, installed an application, or performed any other suitable action. Including actions in targeting criteria allows advertisers to further refine users eligible to be presented with advertisement content from an ad request. As another example, targeting criteria identifies users having a connection to another user or object or having a particular type of connection to another user or object.

Targeting criteria included in an ad request specifies a target audience for the ad request that includes users having characteristics having characteristics satisfying at least a threshold number of the targeting criteria included in the ad request. Users in the target audience for the ad request are eligible to be presented with the advertisement in the ad request. In some embodiments, targeting criteria included in the ad request comprises information identifying specific users of the online system 140, allowing a user providing the ad request to the online system 140 to identify specific online system users eligible to be presented with the advertisement in the ad request.

In various embodiments, the ad request also includes one or more rules that associate weights with users in the target audience for the ad request based on characteristics of the users. A rule identifies a characteristic of a user and a weight associated with a user having the identified characteristic. For example, a rule identifies a specific weight associated with a characteristic of indicating a preference for a specific content item via the online system 140. Additionally, a rule may identify a combination of characteristics and associate a weight with the combination of characteristics, which associates the weight with a user having the combination of characteristics. As further described below, the cluster group generator 235 uses the rules included in the ad request to generate a cluster group associated with the ad request that includes additional users who do not have characteristics satisfying at least a threshold number of targeting criteria included in the ad request. Hence, the rules allow the online system 140 to increase the number of users eligible to be presented with the advertisement from the ad request by generating the cluster group.

The cluster group generator 235 generates a cluster model for the ad request and applies the cluster model to characteristics of a user who does not have characteristics satisfying at least a threshold number (or at least a threshold percentage) of targeting criteria included in the ad request to generate a cluster score for the user. If the cluster score equals or exceeds a cluster group cutoff score, the cluster group generator 235 includes the user in a cluster group associated with the ad request. Therefore, the cluster group associated with the ad request includes users who do not have characteristics satisfying at least the threshold number (or at least the threshold percentage) of targeting criteria and having cluster scores equaling or exceeding the cluster group cutoff score.

In various embodiments, the cluster model generated by the cluster group generator 235 comprises cluster model parameters, which are values applied to various characteristics of a user to generate a cluster score for the user based on the user's characteristics and the values. For example, the cluster model parameters are weights applied to various characteristics of a user by the cluster model to generate a cluster score by combining the weighted user characteristics. The cluster model generator 235 determines cluster model parameters based on one or more rules included in the ad request identifying characteristics of users and weights associated with users having the identified characteristic. For example, the cluster model parameters applied to characteristics of users are the weights associated with the characteristics by the one or more rules included in the ad request. In other embodiments, the cluster group generator 235 determines cluster model parameters for the cluster model associated with the ad request by identifying users in the target audience for the ad request (i.e., users having characteristics satisfying at least the threshold number or at least the threshold percentage of targeting criteria included in the ad request), retrieving characteristics of users in the target audience from one or more of the user profile store 205, the action log 220, and the edge store 225. Based on the retrieved characteristics and rules from the ad request associating weights with various characteristics, the cluster model generator 235 determines cluster model parameters applied to characteristics of a user outside of the target audience of the ad request to determine a measure of affinity of the user for the advertisement in the ad request. For example, the cluster group generation module 235 identifies various combinations of characteristics of a user in the target audience for the ad request and determines cluster model parameters for determining an affinity of a user for the advertisement in the ad request based on the weights associated with characteristics of users by the one or more rules in the ad request and characteristics of users in the target audience. The cluster group generator 235 stores the cluster model for the ad request in association with an identifier of the ad request.

Based on the cluster model for the ad request, the cluster group generator 235 determines a cluster score for a user who is not in the target audience for the ad request. The cluster score represents a measure of a user's affinity for the advertisement in the ad request based on characteristics of the user. Characteristics of a user may be retrieved from one or more of the user profile store 205, the action log 220, and the edge store 225. The cluster score is determined from the cluster model associated with the ad request and stored by the cluster group generator 235 and provides an indication of a likelihood of a user not in the target audience for the ad request interacting with the advertisement included in the ad request. The cluster score for a user may be determined based on a subset of the user's characteristics or based on the full characteristics of the user in various embodiments.

The cluster group generator 235 compares a cluster score for a user not in the ad request's target audience to a cluster group cutoff score for a cluster group associated with the ad request. If the cluster score for the user determined by the cluster model associated with the ad request equals or exceeds the cluster group cutoff score for the cluster group, the cluster group generator 235 includes the user in the cluster group associated with the ad request. Users included in the cluster group associated with the ad request are eligible to be presented with the advertisement from the ad request, even though users in the cluster group do not have characteristics satisfying at least the threshold number or the threshold percentage of the targeting criteria included in the ad request. The cluster group generator 235 may determine the cluster group cutoff score for the cluster group associated with the ad request as further described in U.S. patent application Ser. No. 14/290,355, filed on May 29, 2014, which is hereby incorporated by reference in its entirety.

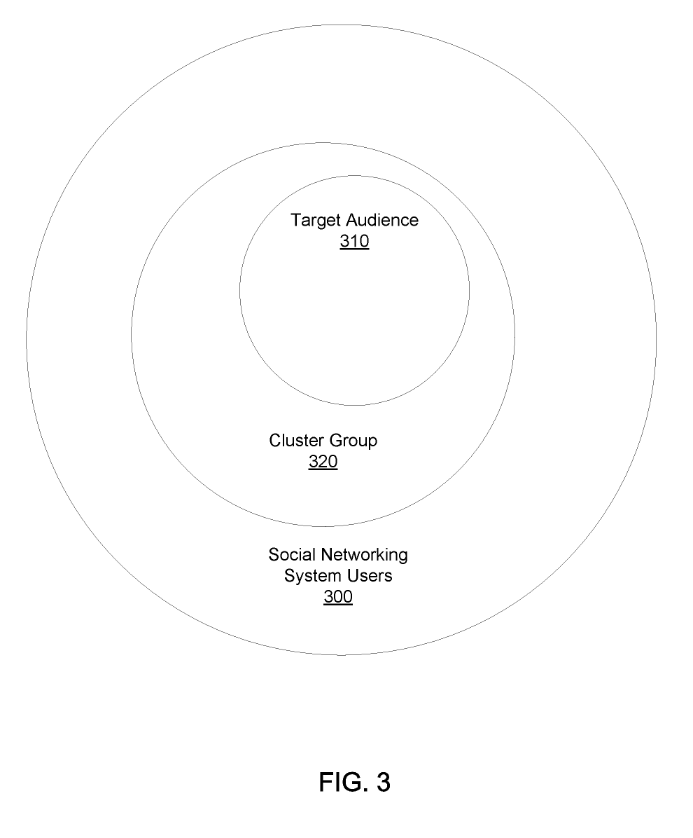

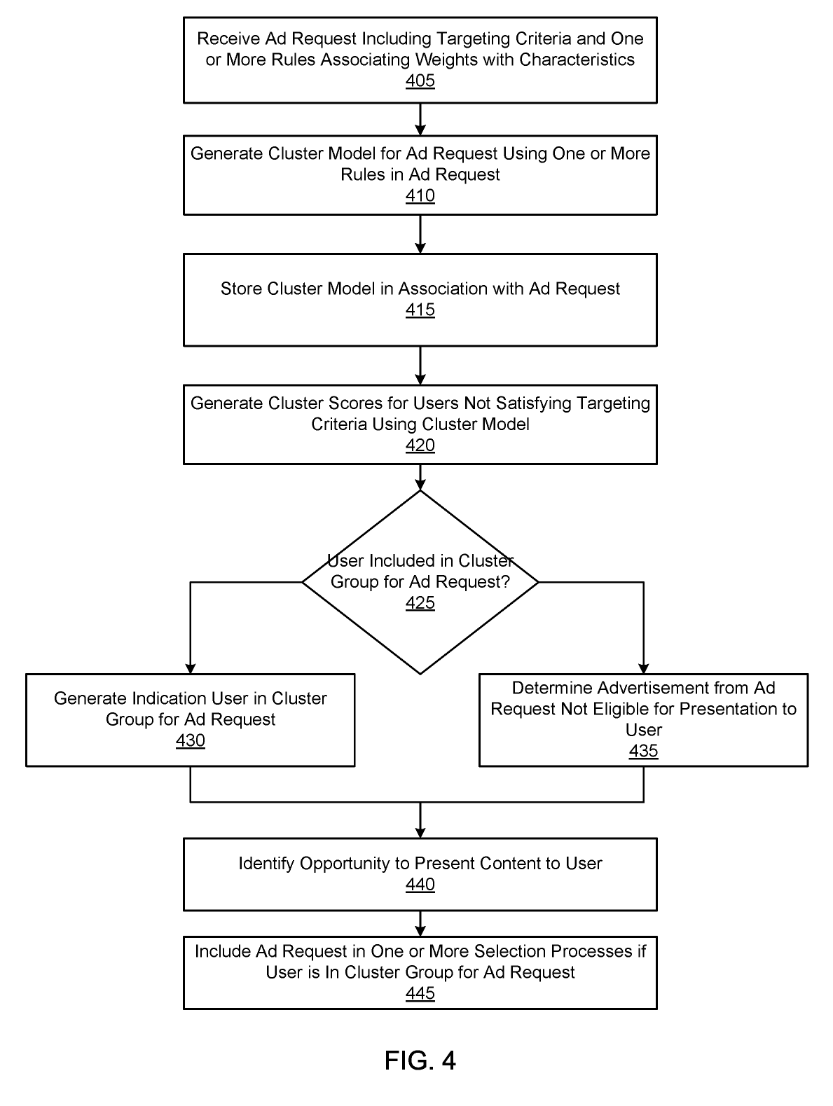

FIG. 3 shows an example of a target audience 310 and a cluster group 320 for an advertisement request received by the online system 140. The online system 140 includes a plurality of users 300 who are presented with content, which includes ad requests, by the online system 140. The target audience 310 comprises users of the plurality of users 300 having characteristics that satisfy at least a threshold number or at least a threshold percentage of targeting criteria included in the ad request. As further described below in conjunction with FIG. 4, the cluster group generator 235 identifies a cluster group 320 of users associated with the ad request based at least in part on characteristics of users in the target group and on one or more rules included in the ad request that associate weights with characteristics of users. In one embodiment, the cluster group 320 includes a subset of the plurality of users 300 having a cluster score, which is generated based on characteristics of the user and a cluster model for the ad request determined from the one or more rules in the ad request associating weights with characteristics of users, equaling or exceeding a cluster group cutoff score. For example, the online system 140 applies a model trained using the one or more rules associating weights with characteristics of users from the ad request to characteristics of users in the target group 310 and to characteristics of users from the plurality of users 300 to generate cluster scores for various users and includes users having cluster scores equaling or exceeding the cluster group cutoff score in the cluster group 320, as further described below in conjunction with FIG. 4.

Referring back to FIG. 2, the content selection module 240 selects one or more content items for communication to a client device 110 to be presented to a user. Content items eligible for presentation to the user are retrieved from the content store 210, from the ad request store 230, or from another source by the content selection module 240, which selects one or more of the content items for presentation to the user. A content item eligible for presentation to the user is a content item associated with at least a threshold number of targeting criteria satisfied by characteristics of the user or is a content item that is not associated with targeting criteria. In various embodiments, the content selection module 240 includes content items eligible for presentation to the user in one or more selection processes, which identify a set of content items for presentation to the user. For example, the content selection module 240 determines measures of relevance of various content items to the user based on characteristics associated with the user by the online system 140 and based on the user's affinity for different content items. Information associated with the user included in the user profile store 205, in the action log 220, and in the edge store 225 may be used to determine the measures of relevance. Based on the measures of relevance, the content selection module 240 selects content items for presentation to the user. As an additional example, the content selection module 240 selects content items having the highest measures of relevance or having at least a threshold measure of relevance for presentation to the user. Alternatively, the content selection module 240 ranks content items based on their associated measures of relevance and selects content items having the highest positions in the ranking or having at least a threshold position in the ranking for presentation to the user.

Content items selected for presentation to the user may include advertisements from ad requests or other content items associated with bid amounts. The content selection module 240 uses the bid amounts associated with ad requests when selecting content for presentation to the viewing user. In various embodiments, the content selection module 240 determines an expected value associated with various ad requests (or other content items) based on their bid amounts and selects advertisements from ad requests associated with a maximum expected value or associated with at least a threshold expected value for presentation. An expected value associated with an ad request or with a content item represents an expected amount of compensation to the online system 140 for presenting an advertisement from the ad request or for presenting the content item. For example, the expected value associated with an ad request is a product of the ad request's bid amount and a likelihood of the user interacting with the ad content from the ad request. The content selection module 240 may rank ad requests based on their associated bid amounts and select advertisements from ad requests having at least a threshold position in the ranking for presentation to the user. In some embodiments, the content selection module 240 ranks both content items not associated with bid amounts and ad requests in a unified ranking based on bid amounts associated with ad requests and measures of relevance associated with content items and with ad requests. Based on the unified ranking, the content selection module 240 selects content for presentation to the user. Selecting ad requests and other content items through a unified ranking is further described in U.S. patent application Ser. No. 13/545,266, filed on Jul. 10, 2012, which is hereby incorporated by reference in its entirety.

When identifying content items eligible for presentation to a user, if the user does not have characteristics satisfying at least a threshold number or a threshold percentage of the targeting criteria associated with a content item (e.g., an ad request), the content selection module 240 accesses the cluster group generator 235 to determine if the user is included in a cluster group associated with the content item. In some embodiments, the cluster group generator 235 maintains information identifying users in a cluster group associated with a content item in association with an identifier of the content item, so the content selection module 240 determines wither the cluster group generator 235 includes an association between information identifying the user and information identifying the content item. If the cluster group generator 235 includes an association between the user and the content item, the content selection module 240 determines the user is included in a cluster group associated with the content item, so the content selection module 240 identifies the user as eligible to be presented with the content item. However, if the cluster group generator 235 does not include an association between the user who does not have characteristics satisfying at least a threshold number or a threshold percentage of the targeting criteria associated with the content item and the content item, the user is not eligible to be presented with the content item.

In other embodiments, the content selection module 240 identifies a user who does not have characteristics satisfying at least a threshold number or a threshold percentage of targeting criteria associated with a content item and the content item to the cluster group generator 235, which obtains a cluster model associated with the content item and generates a cluster score for the user based on characteristics of the user and the cluster model associated with the content item, as further described above. Based on the cluster score for the user, the cluster group generator 235 determines if the user is included in a cluster group associated with the content item and communicates the determination to the content selection module 240. If the determination from the cluster group generator 235 indicates the user is included in the cluster group associated with the content item, the content selection module 240 includes the content item in one or more selection processes selecting content for the user. However, if the determination from the cluster group generator 235 indicates the user is not included in the cluster group associated with the content item, the user is not eligible to be presented with the content item, so the content selection module 240 does not include the content item in one or more selection processes selecting content for the user.

For example, the content selection module 240 receives a request to present a feed of content (also referred to as a “content feed”) to a user of the online system 140. The feed may include one or more advertisements as well as content items, such as stories describing actions associated with other online system users connected to the user. The content selection module 240 accesses one or more of the user profile store 205, the content store 210, the action log 220, and the edge store 225 to retrieve information about the user and selects content items based on the retrieved information. For example, information describing actions associated with other users connected to the user or other data associated with users connected to the user is retrieved and used to select content items describing actions associated with one or more of the other users. Additionally, one or more ad requests may be retrieved from the ad request store 230. The retrieved ad requests and other content items are analyzed by the content selection module 240 to identify candidate content items that are likely to be relevant to the user. For example, content items associated with users who not connected to the user or content items associated with users for whom the user has less than a threshold affinity are discarded as candidate content items. Based on various criteria, the content selection module 240 selects one or more of the candidate content items or ad requests identified as candidate content items for presentation to the user. The selected content items or advertisements from selected ad requests are included in a feed of content that is presented to the user. For example, the feed of content includes at least a threshold number of content items describing actions associated with users connected to the user via the online system 140.

In various embodiments, the content selection module 240 presents content to a user through a feed including a plurality of content items selected for presentation to the user. One or more advertisements may also be included in the feed. The content selection module 240 may also determine an order in which selected content items or advertisements are presented via the feed. For example, the content selection module 240 orders content items or advertisements in the feed based on likelihoods of the user interacting with various content items or advertisements.

The web server 245 links the online system 140 via the network 120 to the one or more client devices 110, as well as to the one or more third party systems 130. The web server 140 serves web pages, as well as other web-related content, such as JAVA®, FLASH®, XML and so forth. The web server 245 may receive and route messages between the online system 140 and the client device 110, for example, instant messages, queued messages (e.g., email), text messages, short message service (SMS) messages, or messages sent using any other suitable messaging technique. A user may send a request to the web server 245 to upload information (e.g., images or videos) that are stored in the content store 210. Additionally, the web server 245 may provide application programming interface (API) functionality to send data directly to native client device operating systems, such as IOS®, ANDROID™, or BlackberryOS.

Determining a Cluster Group of Users Eligible to be Presented with an Advertisement

FIG. 4 is a flowchart of one embodiment of a method for creating a cluster group for an advertisement request identifying users who do not satisfy targeting criteria included in the advertisement request who are eligible to be presented with an advertisement from the advertisement request (“ad request”). In other embodiments, the method may include different and/or additional steps than those shown in FIG. 4. Additionally, in some embodiments, the steps described in conjunction with FIG. 4 may be performed in different orders than the order described in conjunction with FIG. 4.

The online system 140 receives 405 an advertisement request (“ad request”) from a user that includes an advertisement for presentation to one or more users and a bid amount specifying an amount of compensation the online system 140 receives in exchange for presenting the advertisement in the ad request to a user or in exchange for the user performing one or more interactions with the advertisement in the ad request. Additionally, as further described above in conjunction with FIG. 2, the ad request includes targeting criteria specifying characteristics of users eligible to be presented with the advertisement included in the ad request. Users of the online system 140 having characteristics satisfying at least a threshold number or at least a threshold percentage comprise a target audience of users for the ad request.

The ad request also includes one or more rules associating weights with characteristics of users in the target audience. In some embodiments, the rules associate weights with different users in the target audience based on characteristics of the users in the target audience. Alternatively, the rules associate weights with different characteristics of users in the target audience. For example, a rule identifies a characteristic of a user and a weight associated with a user having the identified characteristic. For example, a rule identifies a specific weight associated with a characteristic of indicating a preference for a specific content item via the online system 140. Additionally, a rule may identify a combination of characteristics and associate a weight with the combination of characteristics, so the weight is associated with a user having the combination of characteristics. In some embodiments, rules associate weights based on relative values of users having a characteristic or a combination of characteristics. For example, a rule associates a weight with a user having a characteristic or a combination of characteristics that is greater than a weight associated with another user who does not have the characteristic or the combination of characteristics by a factor that is proportional to a difference in value to the user providing the ad request to the online system 140 (e.g., if a user having the combination of characteristics is three times more valuable to the user providing the ad request than another user who does not have the combination of characteristics, the rules associate a weight with the user having the combination of characteristics that is three times greater than a weight associated with another user who does not have the combination of characteristics).

To increase a number of users eligible to be presented with the advertisement in the ad request, the online system 140 generates a cluster group for the ad request that includes users who do not have characteristics satisfying at least a threshold number or a threshold percentage of targeting criteria included in the ad request. Users in the cluster group have at least a threshold affinity for, or a threshold likelihood of interacting with, the advertisement included in the ad request. The online system 140 generates 410 a cluster model for the ad request based on characteristics of users in the target audience and the one or more rules included in the ad request. The cluster model includes comprises cluster model parameters applied to various characteristics of a user. For example, cluster model parameters are weights corresponding to different characteristics of the user, and the cluster model combines the weights to obtain a cluster score for the user. Different cluster model parameters are determined from weights associated with users in the target audience (i.e., users having characteristics satisfying at least a threshold number or a threshold percentage of the targeting criteria included in the ad request) by the one or more rules in the ad request or from weights associated with characteristics by the one or more rules in the ad request. For example, a set of cluster model parameters applied to characteristics of users are the weights associated with the characteristics by the one or more rules included in the ad request; the online system 140 may determine cluster model parameters applied to characteristics of users not identified by at least one rule in the ad request as described in U.S. patent application Ser. No. 13/297,117, filed on Nov. 15, 2011, or in U.S. patent application Ser. No. 14/290,355, filed on May 29, 2014, each of which is hereby incorporated by reference in its entirety. In various embodiments, the online system 140 generates 410 the cluster model so a sum of the cluster model parameters is maximized or so a sum of characteristics weighted by the cluster model parameters is maximized. Hence, the online system 140 generates 410 a cluster model for the ad request by determining cluster model parameters corresponding to various characteristics of users based on weights corresponding to characteristics in one or more rules included in the ad request. Additionally, the online system 140 may determine cluster model parameters for characteristics that do not correspond to characteristics in one or more rules included in the ad request based on characteristics of users in the target audience for the ad request (i.e., users having characteristics satisfying at least the threshold number or at least the threshold percentage of targeting criteria included in the ad request), as further described in U.S. patent application Ser. No. 13/297,117, filed on Nov. 15, 2011, or in U.S. patent application Ser. No. 14/290,355, filed on May 29, 2014, each of which is hereby incorporated by reference in its entirety.

The online system 140 stores 415 the cluster model in association with the ad request. For example, the online system 140 stores 415 the cluster model in association with an identifier of the ad request. Subsequently, the online system 140 generates 420 cluster scores for one or more users by applying the cluster model to one or more users who do not have characteristics satisfying at least a threshold number of the targeting criteria. For example, a cluster score for a user is a combination of the cluster model parameters corresponding to characteristics of the user. In some embodiments, the online system 140 identifies users in the target audience of the ad request after receiving 405 the ad request and generates 420 cluster scores for multiple users who are not in the target audience of the ad request by applying the cluster model to characteristics of the users. Alternatively, the online system 140 applies the cluster model to a user after receiving a request for content for the user from a client device 110 associated with the user; when the online system 140 receives the request for content for the user, the online system 140 determines whether the user has characteristics satisfying at least a threshold number or a threshold percentage of the targeting criteria in the ad request and applies the cluster model to the user to generate 420 a cluster score for the user in response to determining the user does not have characteristics satisfying at least a threshold number or a threshold percentage of the targeting criteria in the ad request.

Based on a cluster score generated for a user who does not have characteristics satisfying at least a threshold number or at least a threshold percentage of targeting criteria in the ad request, the online system 140 determines 425 if the user is included in the cluster group for the ad request. In various embodiments, the online system determines 425 the user is included in the cluster group for the ad request if the cluster score for the user equals or exceeds a cluster group cutoff score for the cluster group and determines 425 the user is not included in the cluster group for the ad request if the cluster score for the user is less than the cluster group cutoff score for the cluster group. The online system 140 may determine the cluster group cutoff score using any suitable method, such as the method further described in U.S. patent application Ser. No. 14/290,355, filed on May 29, 2014, which is hereby incorporated by reference in its entirety. In response to determining 425 the cluster score for the user equals or exceeds the cluster group cutoff score for the cluster group for the ad request, the online system 140 generates 430 an indication the user is included in the cluster group for the ad request and is eligible to be presented with the advertisement from the ad request. For example, the indication is the online system 140 storing a user identifier corresponding to the user in association with an identifier of the cluster group for the ad request to indicate the user is included in the cluster group for the ad request. Alternatively, the online system 140 stores an identifier of the cluster group for the ad request in a user profile for the user to indicate the user is included in the cluster group for the ad request. If the online system 140 determines 425 the user is not included in the cluster group, the online system 140 does not store information associated with the user and determines 435 the user is not eligible to be presented with the advertisement in the ad request. The online system 140 may generate and associate a value with the user that has a particular value if the user is included in the cluster group and that has an alternative value if the user is not included in the cluster group. In some embodiments, the online system 140 determines 425 if the user who does not have characteristics satisfying at least a threshold number or at least a threshold percentage of targeting criteria in the ad request is included in the cluster group for the ad request when the online system 140 receives a request for content to present to the user.

When the online system 140 identifies 440 an opportunity to present content to the user who does not have characteristics satisfying at least the threshold number or the threshold percentage of the targeting criteria in the ad request, the online system 140 includes 445 the ad request in one or more selection processes for the user if the online system 140 determined 425 the user was in the cluster group for the ad request. However, if the online system 140 determined 425 the user was not in the cluster group for the ad request, the online system 140 withholds the ad request from the one or more selection processes for the user. Hence, if the user is in the cluster group for the ad request, the online system 140 identifies the user as eligible to be presented with the advertisement from the ad request even though the user does not have characteristics satisfying at least the threshold number or the threshold percentage of the targeting criteria in the ad request.

In some embodiments, the online system 140 generates 420 cluster scores for multiple users who do not have characteristics satisfying at least the threshold number or the threshold percentage of the targeting criteria in the ad request and stores information identifying a cluster group of users for the ad request who have cluster scores equaling or exceeding the cluster group cutoff score for the cluster group. For example, the online system 140 stores information identifying users in the cluster group in association with an identifier of the ad request. When the online system 140 identifies an opportunity to present content to a viewing user (e.g., receives a request for content for the viewing user), the online system 140 determines whether characteristics of the viewing user satisfy at least a threshold number or at least a threshold percentage of the targeting criteria included in the ad request. If the characteristics of the viewing user satisfy at least a threshold number or at least a threshold percentage of the targeting criteria included in the ad request, the online system 140 includes the ad request in one or more selection processes selecting content for the viewing user.

However, in response to determining characteristics of the viewing user do not satisfy at least a threshold number or at least a threshold percentage of the targeting criteria included in the ad request, the online system 140 determines whether the viewing user is included in the cluster group for the ad request. For example, the online system 140 compares information identifying the viewing user with information identifying users in the cluster group for the ad request. In response to determining the viewing user is included in the cluster group for the ad request, the online system 140 includes the ad request in one or more selection processes selecting content for the viewing user. However, if the online system 140 determines the viewing user is not included in the cluster group for the ad request, the online system 140 withholds the ad request from the one or more selection processes selecting content for the viewing user. Hence, the online system 140 includes the ad request in one or more selection processes for the viewing user if the viewing user's characteristics satisfy at least the threshold number or the threshold percentage of the targeting criteria or if the user is included in the cluster group for the ad request.

### SUMMARY

The foregoing description of the embodiments has been presented for the purpose of illustration; it is not intended to be exhaustive or to limit the patent rights to the precise forms disclosed. Persons skilled in the relevant art can appreciate that many modifications and variations are possible in light of the above disclosure.

Some portions of this description describe the embodiments in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

Any of the steps, operations, or processes described herein may be performed or implemented with one or more hardware or software modules, alone or in combination with other devices. In one embodiment, a software module is implemented with a computer program product comprising a computer-readable medium containing computer program code, which can be executed by a computer processor for performing any or all of the steps, operations, or processes described.

Embodiments may also relate to an apparatus for performing the operations herein. This apparatus may be specially constructed for the required purposes, and/or it may comprise a general-purpose computing device selectively activated or reconfigured by a computer program stored in the computer. Such a computer program may be stored in a non-transitory, tangible computer readable storage medium, or any type of media suitable for storing electronic instructions, which may be coupled to a computer system bus. Furthermore, any computing systems referred to in the specification may include a single processor or may be architectures employing multiple processor designs for increased computing capability.

Embodiments may also relate to a product that is produced by a computing process described herein. Such a product may comprise information resulting from a computing process, where the information is stored on a non-transitory, tangible computer readable storage medium and may include any embodiment of a computer program product or other data combination described herein.

Finally, the language used in the specification has been principally selected for readability and instructional purposes, and it may not have been selected to delineate or circumscribe the inventive subject matter. It is therefore intended that the scope of the patent rights be limited not by this detailed description, but rather by any claims that issue on an application based hereon. Accordingly, the disclosure of the embodiments is intended to be illustrative, but not limiting, of the scope of the patent rights, which is set forth in the following claims.

What is claimed is:

1. A method comprising:
retrieving an advertisement request (“ad request”) at an online system, the advertisement request including an advertisement, targeting criteria identifying characteristics of users eligible to be presented with the advertisement, and one or more rules associating weights with characteristics of users;
generating a cluster model for the ad request including cluster model parameters associated with characteristics of users, one or more of the cluster model parameters determined from the one or more rules associating weights with characteristics of users included in the ad request;
generating a cluster score for a user who does not have characteristics satisfying at least a threshold number of the targeting criteria included in the ad request by applying the cluster model to characteristics of the user maintained by the online system;
determining to include the user in a cluster group for the ad request in response to the cluster score for the user equaling or exceeding a cluster group cutoff score for the cluster group; and
including the ad request in one or more selection processes by the online system to select content for presentation to the user in response to the determining.

2. The method of claim 1, further comprising:
excluding the ad request from the one or more selection processes in response to determining not to include the user in the cluster group for the ad request.

3. The method of claim 1, wherein a rule associating weights with characteristics of users associates a weight with a particular characteristic.

4. The method of claim 1, wherein a rule associating weights with characteristics of users associates a weight with a combination of characteristics.

5. The method of claim 1, wherein generating the cluster model for the ad request including cluster parameters associated with characteristics of users comprises:
determining one or more cluster model parameters based on characteristics of users who have characteristics satisfying at least the threshold number of targeting criteria in the ad request; and
determining one or more additional cluster model parameters as weights associated with characteristics of users by one or more rules identifying the characteristics.

6. The method of claim 1, wherein generating the cluster score for the user who does not have characteristics satisfying at least a threshold number of the targeting criteria included in the ad request by applying the cluster model to characteristics of the user maintained by the online system comprises:
combining cluster model parameters of the cluster model corresponding to characteristics of the user.

7. The method of claim 1, wherein generating the cluster score for the user who does not have characteristics satisfying at least a threshold number of the targeting criteria included in the ad request by applying the cluster model to characteristics of the user maintained by the online system comprises:
receiving a request for content for presentation to the user; and
generating the cluster score for the user in response to receiving the request for content for presentation to the user.

8. A method comprising:
retrieving an advertisement request (“ad request”) at an online system, the advertisement request including an advertisement, targeting criteria identifying characteristics of users eligible to be presented with the advertisement, and one or more rules associating weights with characteristics of users;
generating a cluster model for the ad request including cluster model parameters associated with characteristics of users, one or more of the cluster model parameters determined from the one or more rules associating weights with characteristics of users included in the ad request;
generating cluster scores for each of a plurality of users who do not have characteristics satisfying at least a threshold number of the targeting criteria included in the ad request, a cluster score for a user generated by applying the cluster model to characteristics of the user maintained by the online system; and
storing information at the online system identifying a cluster group for the ad request, the cluster group including users of the plurality of users having cluster scores equaling or exceeding a cluster group cutoff score for the cluster group.
determining to include the user in a cluster group for the ad request in response to the cluster score for the user equaling or exceeding a cluster group cutoff score for the cluster group; and
including the ad request in one or more selection processes by the online system to select content for presentation to the user in response to the determining.

9. The method of claim 8, further comprising:
excluding the ad request from the one or more selection processes in response to determining not to include the user in the cluster group for the ad request.

10. The method of claim 8, wherein a rule associating weights with characteristics of users associates a weight with a particular characteristic.

11. The method of claim 8, wherein a rule associating weights with characteristics of users associates a weight with a combination of characteristics.

12. The method of claim 8, wherein generating the cluster model for the ad request including cluster parameters associated with characteristics of users comprises:
determining one or more cluster model parameters based on characteristics of users who have characteristics satisfying at least the threshold number of targeting criteria in the ad request; and
determining one or more additional cluster model parameters as weights associated with characteristics of users by one or more rules identifying the characteristics.

13. The method of claim 8, further comprising:
receiving a request for content for presentation to a viewing user;
determining whether characteristics of the viewing user satisfy at least a threshold number of the targeting criteria included in the ad request;
responsive to determining the characteristics of the viewing user do not satisfy at least the threshold number of the targeting criteria included in the ad request, determining whether the user is included in the cluster group for the ad request; and
including the ad request in one or more selection processes selecting content for presentation to the viewing user in response to determining the user is included in the cluster group for the ad request.

14. The method of claim 13, further comprising:
responsive to the characteristics of the viewing user satisfy at least the threshold number of the targeting criteria included in the ad request, including the ad request in the one or more selection processes selecting content for presentation to the viewing user.

15. The method of claim 13, further comprising:
responsive to determining the user is not included in the cluster group for the ad request and that the characteristics of the viewing user do not satisfy at least the threshold number of the targeting criteria included in the ad request, withholding the ad request from the one or more selection processes selecting content for presentation to the viewing user.

16. A computer program product comprising a computer readable storage medium having instructions encoded thereon that, when executed by a processor, cause the processor to:
retrieve an advertisement request (“ad request”) at an online system, the advertisement request including an advertisement, targeting criteria identifying characteristics of users eligible to be presented with the advertisement, and one or more rules associating weights with characteristics of users;
generate a cluster model for the ad request including cluster model parameters associated with characteristics of users, one or more of the cluster model parameters determined from the one or more rules associating weights with characteristics of users included in the ad request;
generate a cluster score for a user who does not have characteristics satisfying at least a threshold number of the targeting criteria included in the ad request by applying the cluster model to characteristics of the user maintained by the online system;
determine to include the user in a cluster group for the ad request in response to the cluster score for the user equaling or exceeding a cluster group cutoff score for the cluster group; and
include the ad request in one or more selection processes by the online system to select content for presentation to the user in response to the determining.

17. The computer program product of claim 16, wherein a rule associating weights with characteristics of users associates a weight with a particular characteristic.

18. The computer program product of claim 16, wherein a rule associating weights with characteristics of users associates a weight with a combination of characteristics.

19. The computer program product of claim 16, wherein generating the cluster model for the ad request including cluster parameters associated with characteristics of users comprises:
determining one or more cluster model parameters based on characteristics of users who have characteristics satisfying at least the threshold number of targeting criteria in the ad request; and
determining one or more additional cluster model parameters as weights associated with characteristics of users by one or more rules identifying the characteristics.

20. The computer program product of claim 16, wherein generate the cluster score for the user who does not have characteristics satisfying at least a threshold number of the targeting criteria included in the ad request by applying the cluster model to characteristics of the user maintained by the online system comprises:
receive a request for content for presentation to the user; and
generate the cluster score for the user in response to receiving the request for content for presentation to the user.
